(19) United States
(12) Patent Application Publication
(10) Pub. No.: US 2019/0023440 A1
(43) Pub. Date: Jan. 24, 2019

(54) METHOD OF PACKAGING MATTRESS

(71) Applicant: Grantec (Xiamen) Co., Ltd., Xiamen City (CN)

(72) Inventor: Suk Kan Oh, Xiamen City (CN)

(21) Appl. No.: 15/655,830

(22) Filed: Jul. 20, 2017

(51) Int. Cl. B65B 63/02; B65B 11/00; B65B 5/04; B65B 63/04; B68G 15/00

(52) U.S. Cl. CPC B65B 63/02; B65B 11/004; B68G 15/005; B65B 63/04; B65B 5/045

(57) ABSTRACT

A method of packaging a mattress includes the steps of: placing the mattress into a storage bag; compressing the mattress along a height direction of the mattress; vacuuming the storage bag to shrink the storage bag and the mattress to become platy; rolling up the platy mattress to be in a cylindrical shape by means of an apparatus, wherein the platy mattress is wrapped with a wrapping film while the platy mattress is rolled up, thereby retaining the cylindrical mattress and preventing the cylindrical mattress from expanding; and placing the cylindrical and retained mattress into a packaging box to be packaged. The wrapping film has a certain degree of flexibility, so it will not bring an unrecoverable indentation on the mattress.

### BACKGROUND OF THE INVENTION

### Field of the Invention

The present invention relates to a packaging method, and more particularly to a method of packaging a mattress.

### Description of the Prior Art

The existing mattresses are spring mattresses or sponge mattresses. The overall mattress is huge in size, so its packaging and transportation is very inconvenient. Accordingly, the inventor of the present invention has devoted himself based on his many years of practical experiences to solve these problems in order to reduce the size of the mattress to be packaged and transported so as to reduce the transportation cost and make the mattress more competitive.

A packaging method is to place a mattress in a storage bag. The mattress is compressed and vacuumized to shrink the mattress to become platy, and then the platy mattress is rolled up to be placed into a cylindrical packaging bag made of plastics or a non-woven fabric. Finally, the shape of the mattress is retained and the mattress is placed in a packaging box for transportation. However, the mattress placed in the packaging box relies entirely on the binding of the packaging bag and the packaging box. The mattress after folded or rolled up has a certain accumulated energy to expand. During transportation, the cylindrical mattress may expand to deform the packaging bag or to break the packaging box, affecting the integrity of the packaging. In addition, the packaging bag is produced separately, which increases the packaging cost of the mattress.

Thus, the inventor of the present invention has invented another method for packaging a mattress. The mattress is wound with an adhesive tape by using an apparatus while the mattress is rolled up, thereby preventing the cylindrical mattress from expanding so as to retain the cylindrical mattress. However, although the tape provides a retaining effect, it may bring an unrecoverable indentation on the mattress after a long period of time to affect the appearance of the use of the mattress.

### SUMMARY OF THE INVENTION

The primary object of the present invention is to provide a method of packaging a mattress. The method can reduce the packaging size of the mattress and ensure the integrity of a packaging box and provide a better protection function.

In order to achieve the aforesaid object, a method of packaging a mattress comprises the steps of:

step 1, placing the mattress into a storage bag;

step 2, compressing the mattress along a height direction of the mattress to reduce the height of the mattress;

step 3, vacuuming the storage bag to shrink the storage bag and the mattress to become platy;

and characterized by:

step 4, rolling up the platy mattress to be in a cylindrical shape by means of an apparatus, wherein the platy mattress is wrapped with a wrapping film while the platy mattress is rolled up, thereby retaining the cylindrical mattress and preventing the cylindrical mattress from expanding; and

step 5, placing the cylindrical and retained mattress into a packaging box to be packaged.

Preferably, in the step 4, the mattress is wrapped with a layer of nonwoven fabric or paper while the mattress is rolled up, after that, the cylindrical mattress is wrapped with the wrapping film for retaining the cylindrical mattress and preventing the cylindrical mattress from expanding.

Preferably, before the step 5, the cylindrical mattress wound with the wrapping film is first placed into a woven bag and then placed into the packaging box.

Preferably, the wrapping film is a polyethylene film.

According to the above-mentioned packaging method of the present invention, the mattress is first compressed and vacuumized to shrink the mattress to become platy, and then the platy mattress is rolled up, so that the whole mattress is reduced to be the minimum. The wrapping film is used to retain the cylindrical mattress for preventing the packaging box from being damaged by the accumulated energy of the cylindrical mattress. This way can ensure the integrity of the packaging box to achieve the reliability of transportation. Because the wrapping film has a larger frictional force between two layers of the wrapping film, the cylindrical mattress can be retained effectively, thereby preventing the mattress from expanding. The wrapping film has a certain degree of flexibility, so it will not bring an unrecoverable indentation on the mattress.

### BRIEF DESCRIPTION OF THE DRAWINGS

FIG. 1 is a packaging flow chart of the present invention;

FIG. 2 is a first schematic view of the packaging process of the present invention (placing the mattress in the storage bag);

FIG. 3 is a second schematic view of the packaging process of the present invention (compressing the mattress and vacuumizing the storage bag);

FIG. 4 is a third schematic view of the packaging process of the present invention (rolling up the mattress); and

FIG. 5 is a schematic view of the present invention after packaging (placing the mattress in a packaging box).

### DETAILED DESCRIPTION OF THE PREFERRED EMBODIMENTS

Embodiments of the present invention will now be described, by way of example only, with reference to the accompanying drawings.

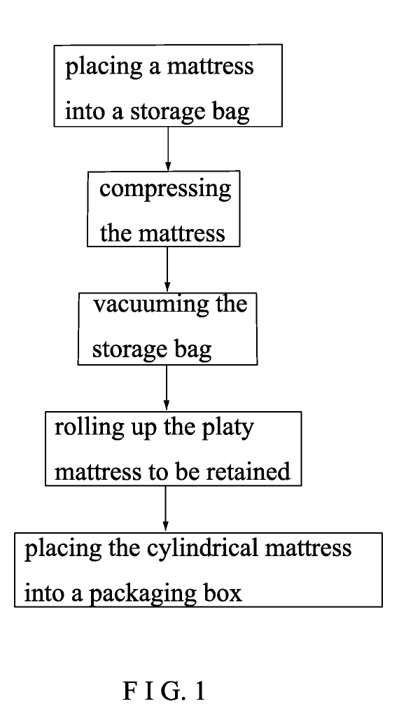

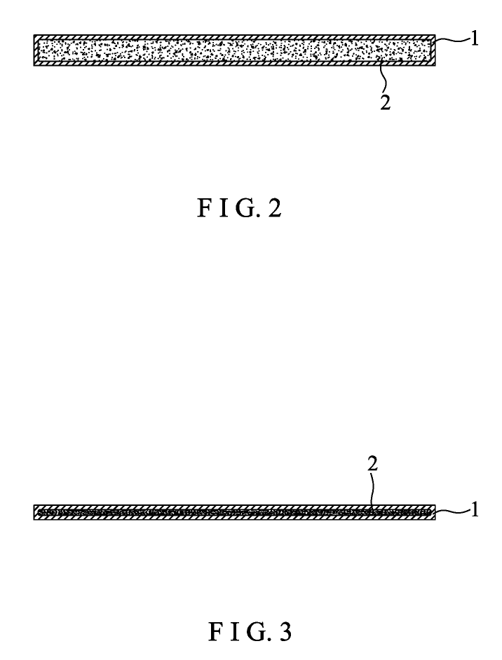

As shown in FIG. 1 in conjunction with FIG. 2 to FIG. 5, the present invention discloses a method for packaging a sponge mattress, comprising the steps of:

step 1, referring to FIG. 2, a mattress 2 is placed into a storage bag 1;

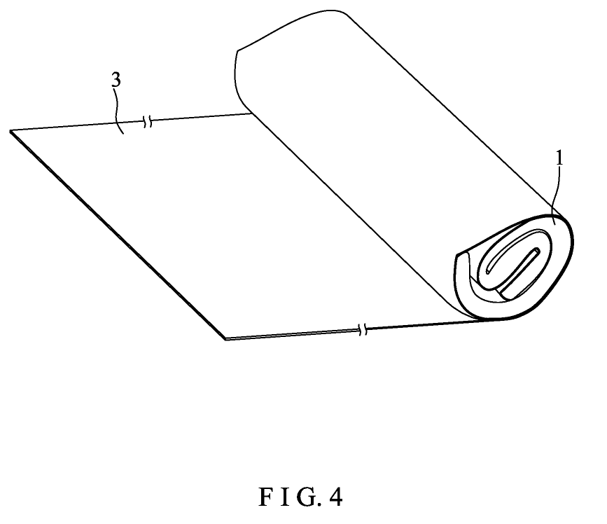

step 2, referring to FIG. 3, the mattress 2 is compressed along a height direction of the mattress 2 by means of a machinery apparatus to reduce the height of the mattress 2;

step 3, the storage bag 1 is vacuumized so that the air in the storage bag 1 and the mattress 2 is evacuated to shrink the storage bag 1 and the mattress 2 to become platy;

The present invention is characterized by:

step 4, referring to FIG. 4, the platy mattress 2 is rolled up to be in a cylindrical shape by means of an apparatus. Wherein, the platy mattress 2 is wrapped with a wrapping film 3 while the platy mattress 2 is rolled up. The wrapping film 3 is a polyethylene film Because the wrapping film 3 has a larger frictional force between two layers of the wrapping film, the cylindrical mattress 2 can be retained effectively, thereby preventing the mattress 2 from expanding. The wrapping film 3 has a certain degree of flexibility, so it will not bring an unrecoverable indentation on the mattress.

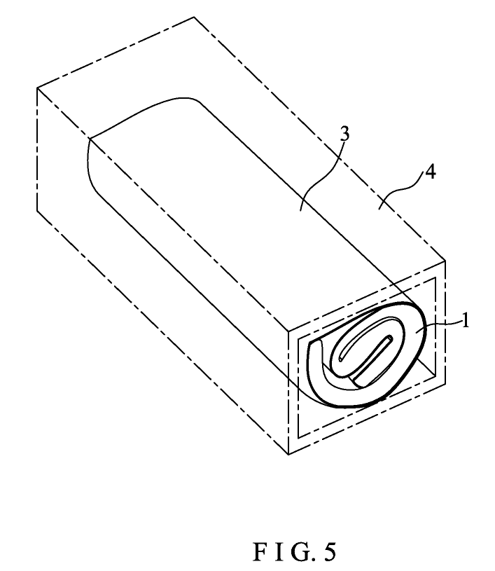

Step 5, as shown in FIG. 5, the cylindrical and retained mattress 2 is placed into a packaging box 4 to be packaged so that the packaging of the mattress is completed.

In order to achieve a better protection function for the mattress 2, in step 4, the mattress 2 may be wrapped with a layer of nonwoven fabric or paper while the mattress 2 is rolled up, after that, the cylindrical mattress 2 is wrapped with the wrapping film 3 to prevent it from expanding.

Before step 5, the cylindrical mattress 2 wound with the wrapping film 3 is first placed into a woven bag and then placed into the packaging box 4 for further protection of the mattress.

The present invention utilizes the wrapping film having a good elasticity and a frictional property to prevent the packaging box 4 from being damaged by the accumulated energy of the cylindrical mattress 2. This way can ensure the integrity of the packaging box 4 to achieve the reliability of transportation and can prevent an unrecoverable indentation on the mattress 2 to provide a better competitiveness on the market.

What is claimed is:

1. A method of packaging a mattress, comprising the steps of:
step 1, placing the mattress into a storage bag;
step 2, compressing the mattress along a height direction of the mattress to reduce the height of the mattress;
step 3, vacuuming the storage bag to shrink the storage bag and the mattress to become platy;
and characterized by:
step 4, rolling up the platy mattress to be in a cylindrical shape by means of an apparatus, wherein the platy mattress is wrapped with a wrapping film while the platy mattress is rolled up, thereby retaining the cylindrical mattress and preventing the cylindrical mattress from expanding; and
step 5, placing the cylindrical and retained mattress into a packaging box to be packaged.

2. The method as claimed in claim 1, wherein the wrapping film is a polyethylene film

3. The method as claimed in claim 1, wherein in the step 4, the mattress is wrapped with a layer of nonwoven fabric or paper while the mattress is rolled up, after that, the cylindrical mattress is wrapped with the wrapping film for retaining the cylindrical mattress and preventing the cylindrical mattress from expanding.

4. The method as claimed in claim 3, wherein the wrapping film is a polyethylene film.

5. The method as claimed in claim 1, wherein before the step 5, the cylindrical mattress wound with the wrapping film is first placed into a woven bag and then placed into the packaging box.

6. The method as claimed in claim 5, wherein the wrapping film is a polyethylene film
